(19) United States
(12) Patent Application Publication
(10) Pub. No.: US 2018/0053273 A1
(43) Pub. Date: Feb. 22, 2018

(54) SYSTEM FOR STORING AND SAFEKEEPING A DOCUMENT

(71) Applicant: Brian Beal, Phoenix, AZ (US)

(72) Inventor: Brian Beal, Phoenix, AZ (US)

(21) Appl. No.: 15/239,706

(22) Filed: Aug. 17, 2016

(51) Int. Cl. G06Q 50/18; G06F 21/62

(52) U.S. Cl. CPC G06Q 50/186; G06F 21/6245

(57) ABSTRACT

A user requests safekeeping of an important document, such as a will, a trust instrument or an insurance policy, via a cloud-based system. The system maintains information relating to storage of the document. In an embodiment, the document is encrypted and securely uploaded to a database. In other embodiments, the document alternatively or additionally can be stored in a physical storage facility (e.g., as a paper document) and the database can maintain indexing and metadata corresponding to the stored document. In various embodiments, at least one condition can be established for release of the document, such as the death of a testator. In an embodiment, a likelihood of the condition being satisfied is assessed using searches of publicly available information, including analysis of free form text for keywords weighted according to probabilities. Further inquiry is made to confirm the condition, such as by calling, texting, or via email.

### BACKGROUND OF THE INVENTION

### 1. Field of the Invention

The present invention relates to document storage and access, and more particularly, to a computer system and computer-implemented method for document storage and safekeeping.

### 2. Description of the Related Art

Estate-planning documents such as wills and trusts are often handled by an attorney who will keep a copy for a nominal fee. However, over time, the original relationship with the lawyer may not be maintained. For instance, after having a will drafted, the client may move to another city and not use the same law firm again. Moreover, relatives may not be aware that a particular law firm is holding a will or trust or even that one exists.

Other options for safekeeping estate-planning documents include storing the documents in the home or with another person. However, this creates some degree of risk. The document could be damaged or accidentally thrown out. The document could be destroyed in a fire or natural disaster. Additionally, the contents of the document could be read by anyone with access to it, and, if beneficiaries are unhappy with the decisions made, the document could be altered or destroyed.

An additional option is to store the estate-planning documents in a safe deposit box. However, unless the safety deposit box is jointly managed, the bank will require a court order to allow access to it. Such a court order will usually take considerable time to obtain. In the meantime, the estate will have expenses and bills to take care of. Additionally, relatives of the deceased may not be aware of the safe deposit box.

### SUMMARY OF THE INVENTION

A user requests safekeeping of an important document, such as a will, a trust instrument or an insurance policy, via a cloud-based system. The system maintains information relating to storage of the document. In an embodiment, the document is encrypted and securely uploaded to a database. In other embodiments, the document alternatively or additionally can be stored in a physical storage facility (e.g., as a paper document) and the database can maintain indexing and metadata corresponding to the stored document. In various embodiments, at least one condition can be established for release of the document, such as the death of a testator. In an embodiment, a likelihood of the condition being satisfied is assessed using searches of publicly available information, including analysis of free form text for keywords weighted according to probabilities. Further inquiry is made to confirm the condition, such as by calling, texting, or via email.

### BRIEF DESCRIPTION OF THE DRAWINGS

FIG. 1 illustrates an exemplary implementation of a system for storing and safekeeping a document, according to an embodiment of the present invention.

FIG. 2 illustrates an exemplary block diagram showing example functionality of the system of FIG. 1.

FIG. 3 illustrates an exemplary flow chart illustrating a first method for verifying that a person is alive, in accordance with the present invention.

FIG. 4 illustrates an exemplary flow chart illustrating a second method for verifying that a person is alive, in accordance with the present invention.

### DETAILED DESCRIPTION OF THE INVENTION

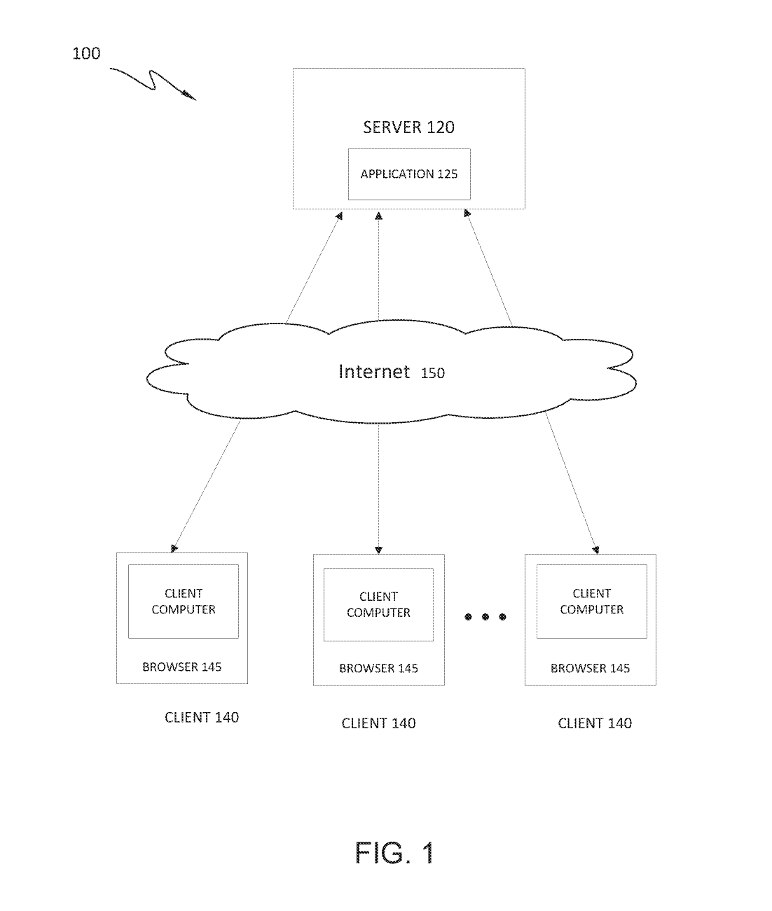

Referring to FIG. 1, an exemplary diagram of a web-based (“Cloud”) system 100 is shown. As depicted, the system 100 includes a distributed application which is partitioned between a service provider (server 120) and a plurality of service requesters (clients 140). Under this arrangement, a request-response protocol, such as hypertext protocol (HTTP), can be employed such that a client 140 can initiate requests for services from the server 120, and the server 120 can respond to each respective request by, for example, executing an application 125 on the server 120, and (where appropriate) sending results to the client 140. The server 120 also includes a database 125 operatively linked to the server, allowing the application 125 to query and store data therein. It is to be understood that in some embodiments, however, the database 125 will include indexing and metadata information corresponding to original documents stored in a storage facility. For example, in some embodiments, paper copies of estate planning documents (e.g., wills, trusts) will be maintained. In other embodiments, some or all of the documents will be digitally stored.

Furthermore, it is to be understood that in some embodiments, substantial portions of the application logic may be performed on the client 140 using, for example, the AJAX (Asynchronous JavaScript and XML) paradigm to create an asynchronous web application. Furthermore, it is to be understood that in some embodiments the application 125 can be distributed among a plurality of different servers 120 (not shown).

Preferably, the illustrated entities (the server 120 and the clients 140) communicate via the Internet 150 which provides a path for data communication, and allows exchange of information signals. Although the Internet 150 is depicted as being used for communication among the illustrated entities, it is to be understood that other network elements could, alternatively, or in addition, be used.

In the following description of the present invention, exemplary methods for performing various aspects of the present invention are disclosed. It is to be understood that the steps illustrated herein can be performed by executing computer program code written in a variety of suitable programming languages, such as C, C++, C#, Visual Basic, and Java. It is also to be understood that the software of the invention will preferably further include various Web-based applications 125 that can be written in HTML, PHP, JavaScript, jQuery, etc., accessible by the clients 140 using a suitable browser 145 (e.g., Internet Explorer, Microsoft Edge, Mozilla Firefox, Google Chrome, Safari, Opera).

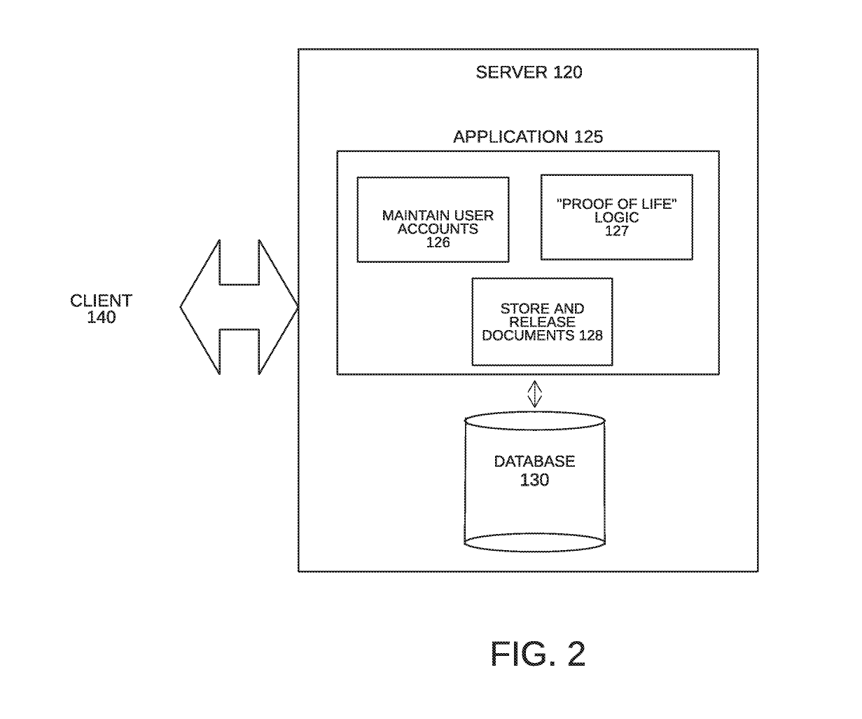

FIG. 2 illustrates an exemplary block diagram showing example functionality of the system of FIG. 1. As shown, the server 120 includes memory for storing an application 125. The application 125 includes a non-transient computer readable medium containing program instructions for causing the server 120 to perform various methods for safekeeping a document, as described herein. Additionally, a database 130 is shown operatively coupled to the application 125. As mentioned, documents could be digitally stored or stored in paper (or other suitable) form. In either case, the database 130 will index the documents. User account information and release condition(s) will further be stored in the database 130. In the case that the documents are digitally stored, they can be stored in the database 130.

As depicted, the application 125 includes various modules to maintain user accounts 126, determine if a specified condition has been met (e.g., verify “Proof of Life”) 127, and store and release documents 128. It is to be understood that the modules 126-128 are presented herein for illustrative purposes, and are not meant to be limiting. Furthermore, it is to be understood that although the example release condition mentioned herein relates to whether a person is presently deceased, another condition or conditions could instead be used depending on the nature of the stored document(s) and user requirements. For instance, if a living will or a “Do Not Resuscitate” order is stored in the database 130 for the user, the condition might involve whether the person was presently incapacitated rather than deceased. As another example, certain trusts are formed so as to distribute trust funds when a beneficiary reaches the age of majority. In this case, the condition might be whether the beneficiary has presently reached the age of majority.

“Maintain User Accounts” 125

The module “Maintain User Accounts” 125 is used to establish and maintain user membership. In an embodiment, the user becomes a member by accessing a web site hosted on the server 120, paying a fee and agreeing to the terms and conditions set forth therein. The fee could be a recurring fee (e.g., monthly, annually) or a one-time fee. The user will choose an appropriate user identifier (or have one assigned) and password. Alternatively or additionally, the authentication process may involve usage of biometric information (e.g., fingerprint or retina scan). Furthermore, the user will provide contact information such as a telephone number and a preferred email address. Additionally, the user may also provide contact information for designated persons to contact. In the case of a will, the contact information could include contact information for the executor of the estate, for example.

“Proof of Life” 125

The module “Proof of Life” 125 is used to verify whether the user (or some other designated person) is presently alive. (As mentioned, a different condition other than whether the person is presently deceased could be established. Accordingly, the following discussion is an example only, and not meant to be limiting.)

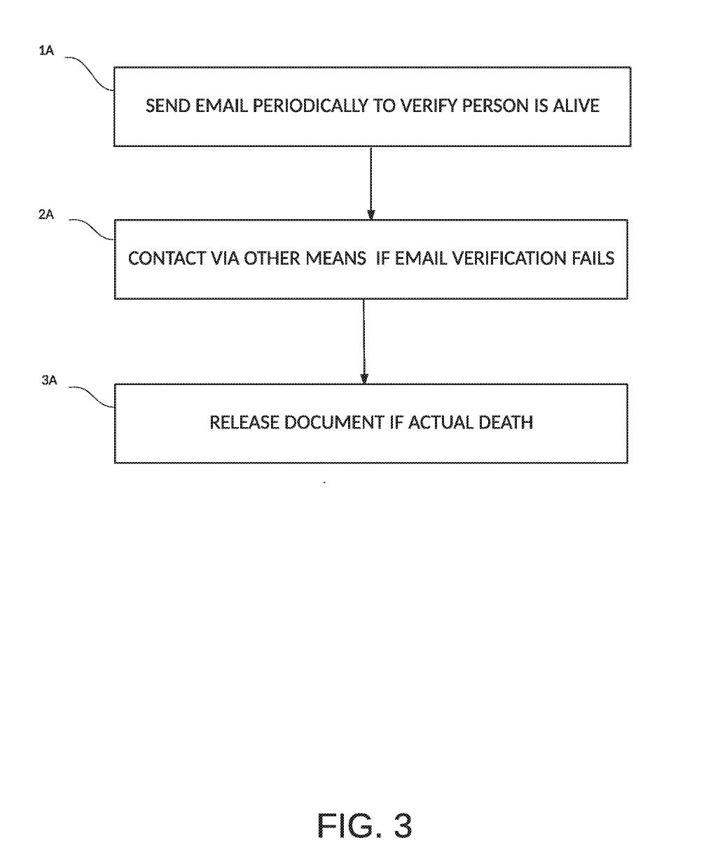

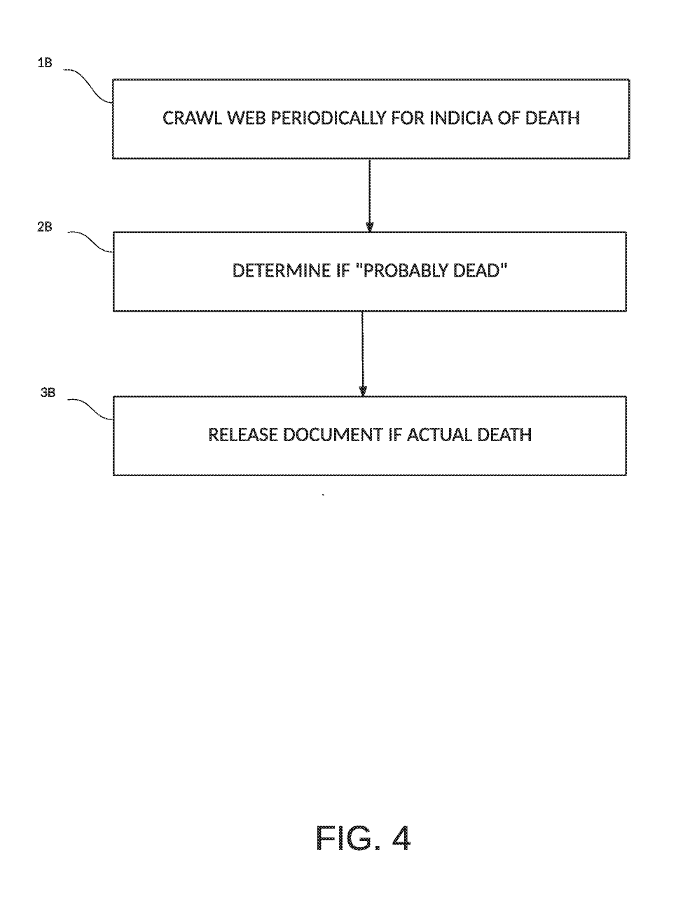

FIGS. 3-4 illustrate preferred methods for verifying if a person is presently alive.

As shown in FIG. 3, a first method for verifying if a person is presently alive is illustrated. At step 1A, email messages are periodically sent to the user to verify if the person is alive. As an example, the system could generate a monthly email message to the user sent to an email address on file requesting the user to simply respond. If no response is received within a predetermined interval (e.g., one week), another email message will be sent. If a response is still not received after several email messages are sent, then at step 2A, the user will be contacted by other means. As an example, a text message or telephone call may be made to the user or a designated contact. As another example, a certified letter can be sent. It is to be understood that although initial use of periodic email messages is mentioned, another suitable type of contact such as a text message could be used instead for this purpose. At step 3A, upon verification of actual death, the stored documents are released to the designated individual(s) (e.g., the executor of a will, the person's spouse).

As shown in FIG. 4, a second method for verifying if a person is presently alive is illustrated. At step 1B, the “Web” is periodically crawled for indicia of the user's death. For example, search engine queries for a predetermined list of keywords associated with a person dying may be performed. The queries can include the person's name (or nickname) along with such words or terms as “obituary,” “obituaries,” “funeral,” “memorial,” “in memory,” “legacy,” “tribute,” “died,” “deceased,” “wake,” and “death,” etc. The queries may be limited by a geographic location (e.g., city, state). Once the search results are obtained, the results are parsed to determine the number of times each of the keywords appears. The search results may include news articles, obituaries, social media postings, tributes, notices, etc., that include free form text. As an example, if the count exceeds a specified value (such as 8), the person will be considered “probably dead.” This analysis can be further refined by comparing historical results of confirmed actual deaths against “probable dead” cases. Further, the analysis may include weighting the keywords. In this case, some keywords would have a greater value when counted (scored). Even further, the analysis may include consideration of context. For example, a recent article in the category of an “obituary” having the user's name, city and state mentioned only once could be weighted higher than a lengthy news article containing the person's name and the word “death” several times therein. If the person is considered “probably dead,” then at step 2B, a process of verifying the death is performed. As above, this may involve contacting a designated person by telephone or certified mail. At step 3B, upon verification of actual death, the stored documents are released to the designated individual(s) (e.g., the executor, the person's spouse).

It is to be understood that both of the “Proof of Life” methods disclosed can be used. Additionally, other methods to verify that a person is presently alive can be used, alone or in conjunction with the “Proof of Life” methods described herein. Further, it is to be understood that release of the stored documents will be done in any case where sufficient evidence that the release condition is satisfied, such as by provision of a death certificate (where the condition is whether the user is deceased), provision of a doctor's note attesting to incapacitation (where the condition is whether the user is incapacitated), provision of a trustee's letter noting a trust condition is met (where the condition is whether a condition of the trust is met), etc.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1) A system for safekeeping a document, comprising:
a client; and
a server;
wherein the client and the server are linked via a network and communicate in accordance with a request-response protocol;
wherein the client is configured to accept user input relating to a request for safekeeping the document; and
wherein the server is configured to:
receive the request;
maintain information relating to storage of the document; and
determine a likelihood a condition related to release of the document has been satisfied.

2) The system of claim 1, wherein the document is a testamentary document.

3) The system of claim 2, wherein the testamentary document is a will.

4) The system of claim 1, wherein the condition is death of a particular person.

5) The system of claim 3, wherein the condition is death of the testator of the will.

6) The system of claim 5, wherein determining the condition involves querying publicly available information for death-related keywords.

7) The system of claim 6, wherein the querying of the publicly available information includes querying an Internet search engine.

8) The system of claim 1, wherein determining the likelihood includes assigning weighted probability values to retrieved information including free form text.

9) The system of claim 1, wherein releasing the document includes releasing the document to a third party.

10) A computer-implemented method for safekeeping a document,
comprising:
receiving a request for safekeeping the document;
maintaining information relating to storage of the document;
determining a likelihood a condition related to release of the document has been satisfied; and
indicating release of the document if the determined likelihood exceeds a predetermined threshold value.

11) The computer-implemented method of claim 10, wherein the document is a testamentary document.

12) The computer-implemented method of claim 11, wherein the testamentary document is a will.

13) The computer-implemented method of claim 10, wherein the condition is death of a particular person.

14) The computer-implemented method of claim 13, wherein the condition is death of the testator of the will.

15) The computer-implemented method of claim 10, wherein determining the condition involves querying publicly available information for death-related keywords.

16) The computer-implemented method of claim 15, wherein the querying of the publicly available information includes querying an Internet search engine.

17) The computer-implemented method of claim 10, wherein determining the likelihood includes assigning weighted probability values to retrieved information

18) The computer-implemented method of claim 10, wherein releasing the document includes releasing the document to a third party.

19) A non-transient computer readable medium containing program instructions for causing a computer to perform a method for safekeeping a document, comprising:
receiving a request for safekeeping the document;
maintaining information relating to storage of the document;
determining a likelihood a condition related to release of the document has been satisfied; and
indicating release of the document if the determined likelihood exceeds a predetermined threshold value.

20) The non-transient computer readable medium of claim 20, wherein the document is a testamentary document.
